(19) United States
(12) Patent Application Publication
(10) Pub. No.: US 2012/0255401 A1
(43) Pub. Date: Oct. 11, 2012

(54) PAIR OF PLIERS AND A MANUFACTURING METHOD OF THE SAME

(76) Inventors: Wei-Fang Wang, Taichung City (TW); Jian-Lin Huang, Taichung City (TW); Chun-Kai Huang, Taichung City (TW); Chun-Chia Huang, Taichung City (TW)

(21) Appl. No.: 13/083,834

(22) Filed: Apr. 11, 2011

(51) Int. Cl. B25B 7/02; B21K 5/00

(52) U.S. Cl. 81/423; 76/119

(57) ABSTRACT

A pair of pliers has a body and two jaws. The body has two connecting sections and two handles. The jaws are detachably mounted on the connecting sections of the body, and each jaw has a working nose and a mounting section. The mounting section has a mounting hole formed in a bottom surface of the mounting section and corresponding to the connecting section of the body in the shape and having a circular hole with a depth D and a diameter R, an enlarged hole with a depth smaller than the depth D and an inner diameter larger than the diameter R at the circular hole and cutting chips deposited and accumulated in the circular hole and shaped as a hill with a convex top.

### BACKGROUND OF THE INVENTION

1. Field of the Invention

The present invention relates to a pair of pliers and a manufacturing method of the same, and more particularly to a pair of pliers with detachable jaws and each jaw is shaped by a punching process and has a mounting hole formed by a drilling process to simplify the manufacturing processes and decreasing the manufacturing cost of the pair of pliers.

2. Description of Related Art

A conventional pair of pliers has a body implemented by two bars pivotally connected to each other, and the body has two jaws for clipping, pressing or expanding a C-shaped fastener. The body has two handles opposite to the jaws, and skid-proof covers are mounted around the handles to prevent the handles from sliding. The user holds and presses the handles of the pliers to open or close the jaws and to provide a clamping effect or an expanding effect to the C-shaped fastener.

U.S. Pat. No. 7,497,150 discloses another conventional pair of pliers and has a body and multiple detachable jaws that are changeable to fit different needs of the user.

The body has two connecting sections defined in two front ends of the body. Each connecting section has a side surface, a recess, a spring and a ball. The recess is formed in the side surface of the connecting section and has a narrowed opening. The spring is mounted in the recess. The ball is movably mounted in the recess and pressed by the spring and selectively protrudes out of the narrowed opening of the recess.

The jaws are respectively and detachably mounted on the connecting sections of the body. Each jaw has a working section and a mounting section respectively defined in two ends of the jaw. The mounting section is shaped as a rectangular board made by a punching process firstly. The mounting section has two opposite sides respectively punched and formed as a dovetail block and a dovetail groove. The mounting section is further punched and bent to mount the dovetail block in the dovetail groove and to form a mounting hole. The mounting hole enables the mounting section to be mounted on the connecting section of the body. An engaging hole is defined in the mounting section, communicates with the mounting hole and engages the ball of the connecting section of the body.

When the ball of the connecting section of the body is engaged in the engaging hole of the mounting section of the jaw, the jaw is mounted on the body stably. When the user wants to change the jaws, the jaws are pulled outwardly and the balls are pressed to disengage from the engaging holes and are retracted into the recesses. Consequently, the jaws can be detached from the body.

However, the conventional pair of pliers needs multifarious processes to form the jaws, and the manufacturing cost is increased. Furthermore, each jaw has a mounting hole formed by punching and bending the board that has two width sides connected with each other by the dovetail block and dovetail groove. Therefore, the board is deformed easily and does not have a sufficient strength against a heavy resisting force.

To overcome the shortcomings, the present invention tends to provide a pair of pliers and a manufacturing method of the same to mitigate or obviate the aforementioned problems.

### SUMMARY OF THE INVENTION

The main objective of the present invention is to provide a pair of pliers with detachable jaws and each jaw is shaped by a punching process and has a mounting hole formed by a drilling process to simplify the manufacturing processes and decrease the manufacturing cost of the pair of pliers.

The pliers has a body and two jaws. The body is implemented by two bars connected pivotally with each other and has two connecting sections and two handles. The jaws are respectively and detachably mounted on the connecting sections of the body, and each jaw has a working nose and a mounting section. The mounting section has a bottom surface and a mounting hole. The mounting hole is formed in the bottom surface of the mounting section and corresponding to the connecting section of the body in the shape and having a circular hole with a depth D and a diameter R, an enlarged hole with a depth smaller than the depth D and an inner diameter larger than the diameter R at the circular hole and cutting chips deposited and accumulated in the circular hole and shaped as a hill with a convex top.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a pair of pliers in accordance with the present invention;

FIG. 2 is a partially enlarged exploded perspective view of the pliers in FIG. 1;

FIGS. 3A to 3D are operational side views in partial section, showing a jaw shaping step of the manufacturing method of the pliers in accordance with the present invention;

FIG. 4A to 4D are operational side views in partial section, showing forming a mounting hole in the jaw shaping step of the manufacturing method of the pliers in FIGS. 3A to 3D;

FIG. 5 is a perspective view of a second embodiment of a pair of pliers in accordance with the present invention, embodied as being a pair of cutting pliers; and

FIG. 6 is a perspective view of a third embodiment of a pair of pliers in accordance with the present invention, embodied as being a pair of needle nose pliers.

### DETAILED DESCRIPTION OF PREFERRED EMBODIMENT

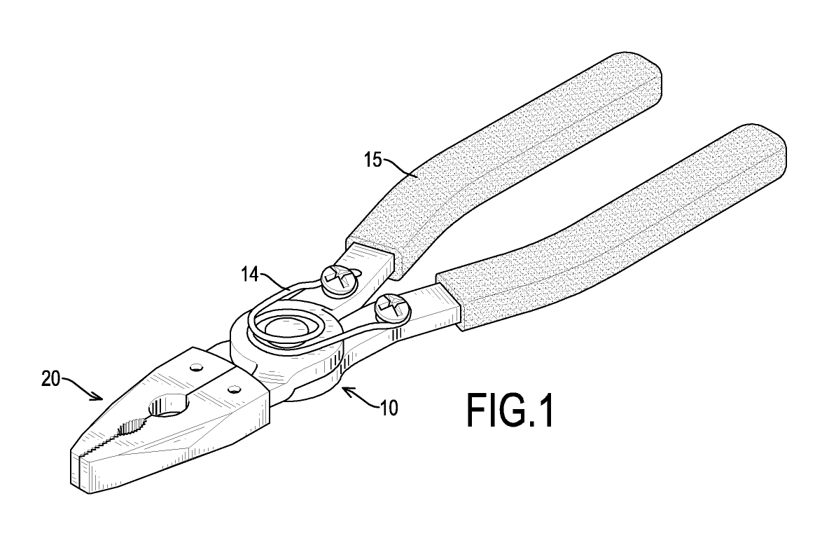

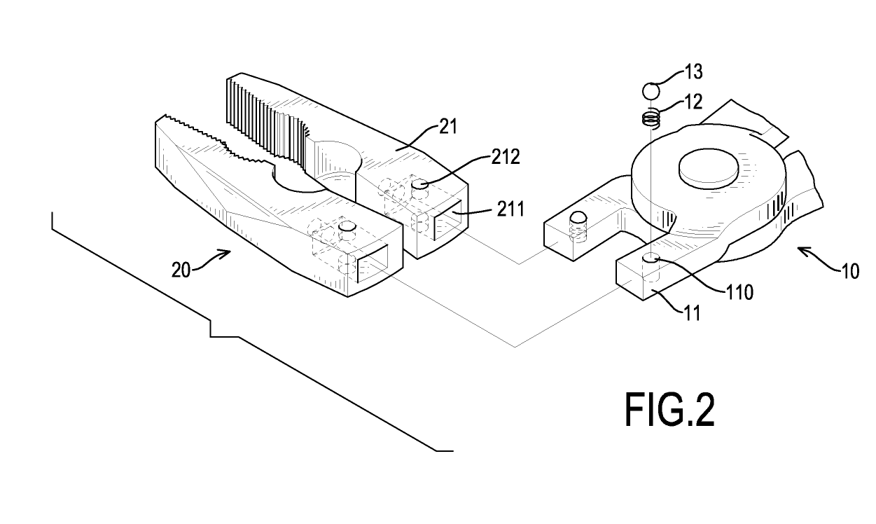

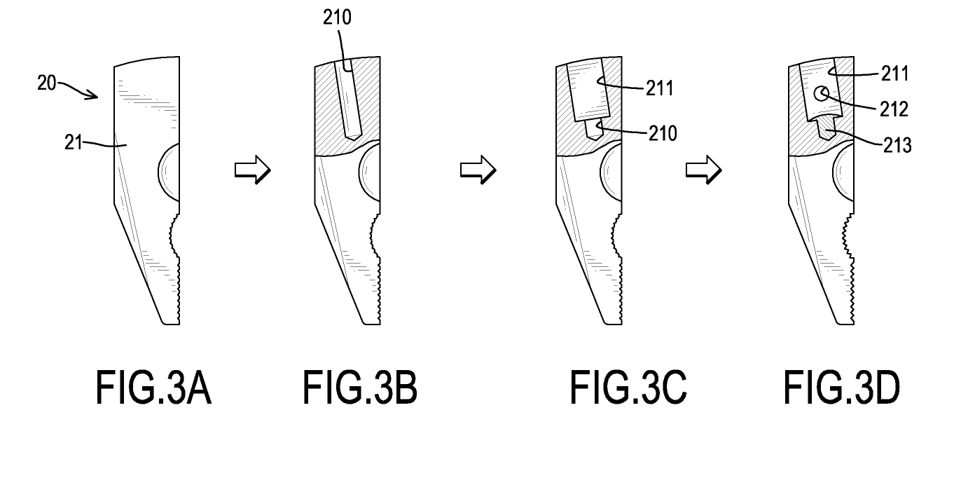

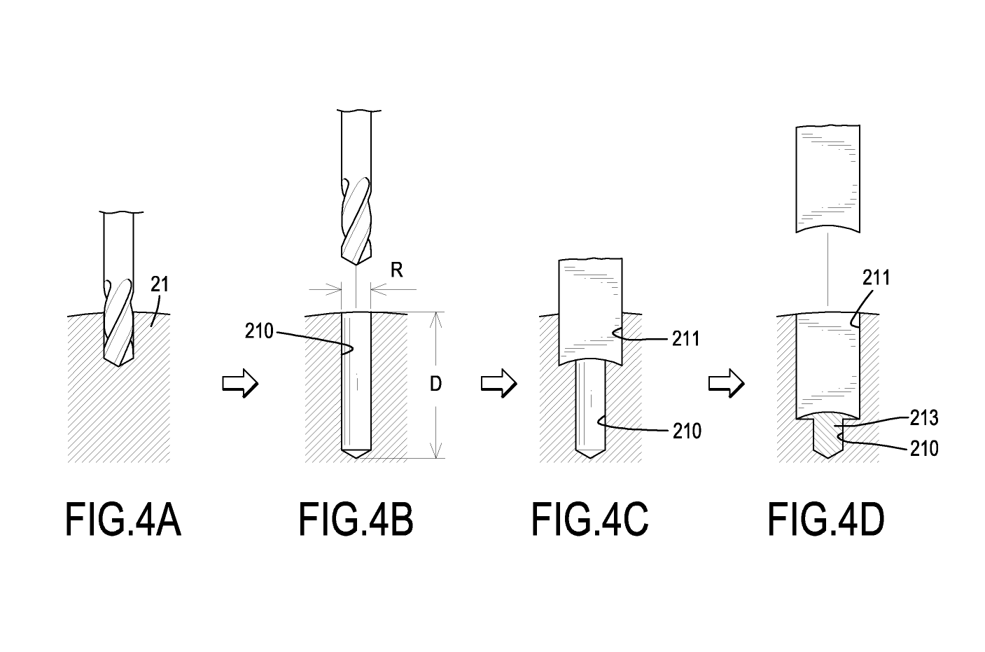

With reference to FIGS. 1 to 4D, a pair of pliers in accordance with the present invention has a body 10, a pair of jaws 20, two springs 12, two balls 13, a torsion spring 14 and two covers 15, and the manufacturing method of the pliers has a body shaping step, a component combining step, a jaw shaping step and a setup step.

In the body shaping step, the body 10 is implemented by two bars respectively made by two punching processes. The bars are connected pivotally with each other, and the body 10 has two front segments, two rear segments, two connecting sections 11, a mouth and two handles. The connecting sections 11 are defined in the front segments of the body 10, and each connecting section 11 is shaped as a rectangular cross section and has a side surface and a recess 110. The recess 110 is formed in the side surface of the connecting sections 11 and has a narrowed opening. The mouth is defined by a space between the connecting sections 11. The handles are defined in the rear segments of the body 10 and enable a user to hold the pair of pliers.

In the component combining step, each spring 12 is mounted in the recess 110 of the connecting section 11, and each ball 13 is movably mounted in the recess 110 of the connecting section 11, is pressed by the spring 12 and selectively protrudes out of the narrowed opening of the recess 110 partially.

The torsion spring 14 is mounted between the rear segments of the body 10 and provides an elasticity to keep the mouth of the body 10 opened or closed in a natural, unpressed condition. The natural condition of the pliers depends on the type of the pliers, for example, a pair of needle nose pliers or a pair of flat pliers in a natural condition keeps the mouth opened, and a pair of retaining ring pliers in a natural condition keeps the mouth closed.

The covers 15 are mounted on and cover the rear segments of the body 10 and provide a skid-proof effect and an easy holding effect. The covers 15 may be made by an injection molding process and directly formed on the rear segments of the body 10, or may be made of two rubber covers and respectively mounted on the rear segments of the body 10.

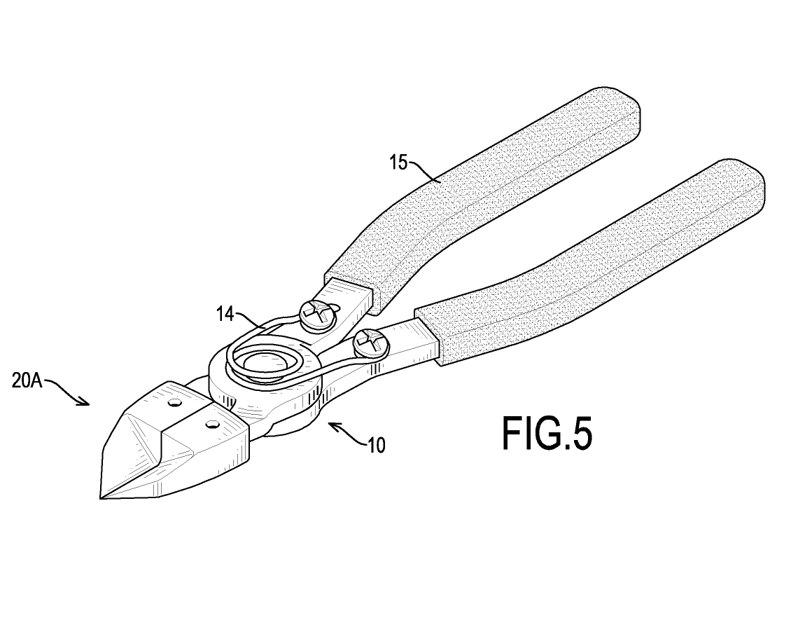

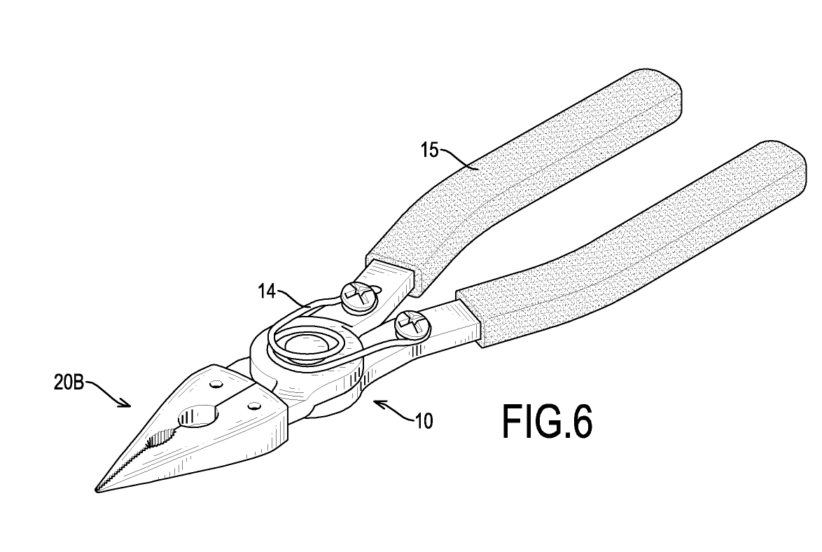

With further reference to FIGS. 5 to 6, in the jaw shaping step, the jaws 20 are respectively shaped and formed by two punching processes, and may have multiple types like two jaws 20A of a pair of cutting pliers or two jaws 20B of a pair of needle nose pliers.

Each jaw 20 has a front segment, a rear segment, a working nose, an inner surface, multiple teeth and a mounting section 21. The working nose is defined in the front segment of the jaw 20 and may be a cutting nose, a needle nose or a flat nose. The inner surface of the jaw 20 faces the inner surface of the other jaw 20. The teeth are shaped and formed on the inner surface of the jaw 20 by a punching process.

The mounting section 21 is defined in the rear segment of the jaw 20 and is detachably mounted on and connected to the connecting section 11 of the body 10. The mounting section 21 has a bottom surface, a side surface, a mounting hole and an engaging hole 212. The bottom surface of the mounting section 21 faces the connecting section 11 of the body. 10. The mounting hole is formed in the bottom surface of the mounting section 21 and corresponds to the connecting section 11 of the body 10 in the shape.

To form the mounting hole, a circular hole 210 is formed by a first drilling process and an enlarged hole 211 is then formed by a second drilling process and cutting chips 213 are deposited and accumulated in the circular hole 210. Additionally, the enlarged hole 211 is formed in the bottom surface of the mounting section 21 and has a bottom, and the circular hole 210 is formed in the bottom of the enlarged hole 211. In the first drilling process, the circular hole 210 is formed in the bottom surface of the mounting section 21 and drilled by a cylindrical drill bit and has an inner surface, a depth D and a diameter R. The depth D of the circular hole 210 is defined from the bottom surface of the mounting section 21 to the inner surface of the circular hole 210.

In the second drilling process, the enlarged hole 211 is formed at the circular hole 210 in the bottom surface of the mounting section 21 and punched and enlarged by a rectangular drill bit with a concave end surface and a sharp annular edge, and has the bottom, a depth and an inner diameter. The depth of the enlarged hole 211 is defined from the bottom surface of the mounting section 21 to the bottom of the enlarged hole 211. The depth of the enlarged hole 211 is smaller than the depth D of the circular hole 210. The inner diameter of the enlarged hole 211 is larger than the diameter R of the circular hole 210.

The second drilling process makes part of the circular hole 210 formed in the bottom of the enlarged hole 211 and communicating with the enlarged hole 211.

During the second drilling process, part of the mounting section 21 located around the circular hole 210 is cut by the sharp annular edge of the rectangular drill bit and cutting chips 213 are peeled off from the mounting section 21 of the jaw 20. The cutting chips 213 are rolled into the circular hole 210 along the concave end surface of the rectangular drill bit and deposited and accumulated in the circular hole 210, and may be accumulated on the bottom of the enlarged hole 211. The cutting chips 213 are shaped as a hill with a convex top based on the shape of the concave end surface of the rectangular drill bit. After the second drilling process, the mounting hole of the mounting section 21 is made.

The engaging hole 212 of the mounting section 21 is formed in the side surface and communicates with the mounting hole of the mounting section 21. When the connecting section 11 of the body 10 is inserted into the mounting hole of the jaw 20, the ball 13 is partially protruding into and engaged in the engaging hole 212 of the mounting section 21 of the jaw 20 and causes the jaw 20 to be mounted on the body 10 stably.

The working nose and the teeth of the jaw 20 are shaped roughly by the punching process previously, and the working nose is further sharpened finely and the teeth are further sawed deeply and clearly by a precision process. After these processes, the jaws 20 are processed with a polishing process and a grinding process are finally accomplished.

In the setup step, the jaws 20 are respectively mounted on the connecting sections 11 of the body 10. When the connecting sections 11 of the body 10 are respectively inserted in the mounting holes of the jaws 20, the balls 13 are respectively engaged in the engaging holes 212 of the mounting sections 21 of the jaws 20 to securely connect the jaws 20 with the connecting sections 11 of the body 10.

Accordingly, the jaws 20 can be manufactured easily and the structural strength of the jaws 20 can be enhanced because the mounting hole is shaped by forming the circular hole 210 with a first drilling process and forming the enlarged hole 211 with a second drilling process so as to make the mounting section 21 of the jaw 20 have a continuous and firm wall. The manufacturing method of the pair of pliers can be efficiently simplified and the manufacturing cost of the pair of pliers can be decreased.

To change different types of jaws 20, the jaws 20 are pulled outwardly relative to the body 10. The jaws 20 press the balls 13 and the springs 12 to disengage the balls 13 from the engaging holes 212 of the mounting sections 21 to be retracted into the recesses 110 of the connecting sections 11. Consequently, the jaws 20 are detached from the body 10, and different types of jaws 20 are then mounted on the body 10 to fit different operational needs.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A manufacturing method of pliers comprising:
a body shaping step of
forming two bars respectively shaped by two punching processes;
forming a body implemented by the bars connected pivotally with each other and the body having
two front segments;
two rear segments;
two connecting sections defined in the front segments of the body; and
two handles defined in the rear segments of the body;
a jaw shaping step of
forming two jaws respectively shaped by two punching processes, and each jaw having
a rear segment; and
a mounting section defined in the rear segment of the jaw and having a bottom surface;
forming two circular holes respectively in the bottom surfaces of the mounting sections of the jaws by a cylindrical drill bit to have a depth D and a diameter R; and
forming two enlarged holes respectively at the circular holes of the mounting sections of the jaws by a rectangular drill bit with a concave end surface and a sharp annular edge and each enlarged hole having a depth smaller than the depth D and an inner diameter larger than the diameter R of the circular hole, and when the enlarged hole being punched, part of the mounting section located around the circular hole being cut by the sharp annular edge of the rectangular drill bit and cutting chips being peeled from the mounting section of the jaw and rolled into the circular hole along the concave end surface of the rectangular drill bit and deposited and accumulated in the circular hole, and the cutting chips being shaped as a hill with a convex top based on the shape of the concave end surface of the rectangular drill bit;
defining two mounting holes respectively in the bottom surfaces of the mounting sections of the jaws, each mounting hole being shaped by the corresponding circular hole, the enlarged hole and the cutting chips;
a setup step making the jaws respectively mounted on the connecting sections of the body by the connecting sections of the body inserted in the mounting holes of the jaws.

2. The manufacturing method of pliers as claimed in claim 1, wherein
the body shaping step further forms a recess with a narrowed opening in a side surface of each connecting section;
the manufacturing method of pliers further has a component combining step after the body shaping step and comprising steps of
implementing two springs respectively mounted in the recesses of the connecting sections; and
implementing two balls respectively and movably mounted in the recesses of the connecting sections and pressed by the springs and selectively protruding out of the narrowed openings of the recesses partially; and
the jaw shaping step further comprises forming an engaging hole in a side surface, communicating with the mounting hole of each mounting section and engaging the ball of the corresponding connecting section of the body.

3. The manufacturing method of pliers as claimed in claim 2, wherein
the components combining step further comprises implementing two covers respectively mounted on and covering the rear segments of the body.

4. The manufacturing method of pliers as claimed in claim 3, wherein the jaws shaping step further comprises steps of
shaping multiple teeth on an inner surface of each jaw roughly by the punching process and then manufactured by a precision process; and
polishing and grinding the jaws.

5. The manufacturing method of pliers as claimed in claim 4, wherein the precision process is sawing the teeth deeply and clearly in the inner surface of each jaw.

6. A pair of pliers comprising:
a body implemented by two bars connected pivotally with each other and having
two front segments;
two rear segments;
two connecting sections defined in the front segments of the body; and
two handles defined in the rear segments of the body; and
two jaws respectively and detachably mounted on the connecting sections of the body, and each jaw having
a front segment;
a rear segment;
a working nose defined in the front segment of the jaw; and
a mounting section defined in the rear segment of the jaw and having
a bottom surface; and
a mounting hole formed in the bottom surface of the mounting section and corresponding to the connecting section of the body in the shape and having
an enlarged hole formed in the bottom surface of the mounting section and having a bottom and an inner diameter;
a circular hole formed in the bottom of the enlarged hole and having a diameter R, wherein the inner diameter of the circular hole is larger than the inner diameter of the enlarged hole; and
cutting chips deposited and accumulated in the circular hole, and shaped as a hill with a convex top.

7. The pair of pliers as claimed in claim 6, wherein
each connecting section has
a side surface; and
a recess formed in the side surface of the connecting sections with a narrowed opening;
the pair of pliers further has
two springs respectively mounted in the recesses of the connecting sections of the body; two balls respectively and movably mounted in the recesses of the connecting sections of the body and respectively pressed by the springs and selectively protruding out of the narrowed openings of the recesses partially; and
each jaw has
a side surface;
an engaging hole formed in the side surface and communicating to the mounting hole of the corresponding mounting section and engaging the corresponding ball.

8. The pliers as claimed in claim 7, wherein a torsion spring is mounted between the rear segments of the body.

9. The pliers as claimed in claim 8, wherein two covers are mounted on the rear segments of the body.
